(19) United States
(12) Patent Application Publication
(10) Pub. No.: US 2015/0225096 A1
(43) Pub. Date: Aug. 13, 2015

(54) SYSTEM FOR PACKAGING PRODUCTS

(71) Applicant: Charlotte Anna Maria LIEDL, (US)

(72) Inventor: Charlotte Anna Maria Liedl, Lana (IT)

(21) Appl. No.: 14/423,392

(22) PCT Filed: Apr. 29, 2014
(86) PCT No.: PCT/IB2014/061075

§ 371 Date: Feb. 23, 2015

(30) Foreign Application Priority Data
Jun. 17, 2013 (IT) MO2013A000172

(51) Int. Cl. B65B 5/10; B65B 57/00; B07C 5/16; B65B 35/10

(52) U.S. Cl. CPC B65B 5/10; B65B 35/10; B65B 57/00; B07C 5/16

(57) ABSTRACT

A system for packaging products, comprising: a sorting machine (2), equipped with a conveying device predisposed to move the products (P) along a first direction (X); a conveyor line (3) predisposed to move a plurality of trays (V) along a second direction (Y); an orientation device (4) predisposed to receive the products (P) from the sorting machine (2) and to orientate the products (P) in a predetermined manner; a positioning device (5), predisposed to pick up the products (P) from the orientation device (4) and to position the products (P) in predetermined positions along the conveyor line (3); the orientation device (4) is interposed between the sorting machine (2) and the conveyor line (3); the first direction (X) and the second direction (Y) are parallel to each other; the positioning device (5) is arranged above the orientation device (4) and the conveyor line (3) so as to operate from above with respect thereto.

### TECHNICAL FIELD

The object of the present invention is a system for packaging fruit.

The invention refers particularly to a system predisposed to insert a given number of pieces of fruit in a package in the form of crates, boxes, tray liners or trays.

In the most widely—used packages, the pieces of fruit inside the crates are arranged on trays that have a plurality of shaped hollows. During the packaging process, the pieces of fruit are first positioned on the trays and the trays are then placed inside boxes or crates.

A common need of packaging systems is that of composing packages that have a total weight that is as close as possible to a standard weight.

To achieve this object, packaging systems comprise a sorting machine, which, as is known, is equipped with a conveyor line along which the products are advanced aligned in a row. The sorting machine is equipped with a weighing device that detects the weight of each individual piece of fruit in transit. The weight of each piece of fruit is stored in a control unit, which thus knows the weight of each piece of fruit moving along the sorting machine.

The sorting machine is also predisposed to unload each piece of fruit laterally with respect to the direction of advancement, in a predetermined unloading position. From this unloading position, the pieces of fruit are then selected based on the weight thereof, picked up and placed on a tray, which will be subsequently placed inside a crate.

In numerous systems, before being positioned in the corresponding trays, the pieces of fruit are also orientated in a predetermined manner. In the case of apples for example, it may be required that the apples be orientated with the stem-calyx axis directed in a certain manner and with a selected colour facing upward. With this aim, these systems comprise a special orientation device.

Therefore, the packaging systems to which the invention refers essentially comprise at least one sorting machine, an orientation device, a conveyor line for the trays and one or more manipulator devices for transferring the pieces of fruit from the sorting machine to the orientation device and from the sorting machine to the trays.

Currently available packaging systems generally have rather complex layouts, which lead to quite a substantial amount of space being occupied. Moreover, moving about such systems often proves to be difficult because of these complex layouts.

The object of the present invention is to offer a system for packaging products such as fruit and vegetables that makes it possible to reduce the dimensions of the total occupied area.

Further characteristics and advantages of the present invention will become more apparent from the following detailed description of an embodiment of the invention at hand, which is illustrated by way of non-limiting example in the attached figures, in which:

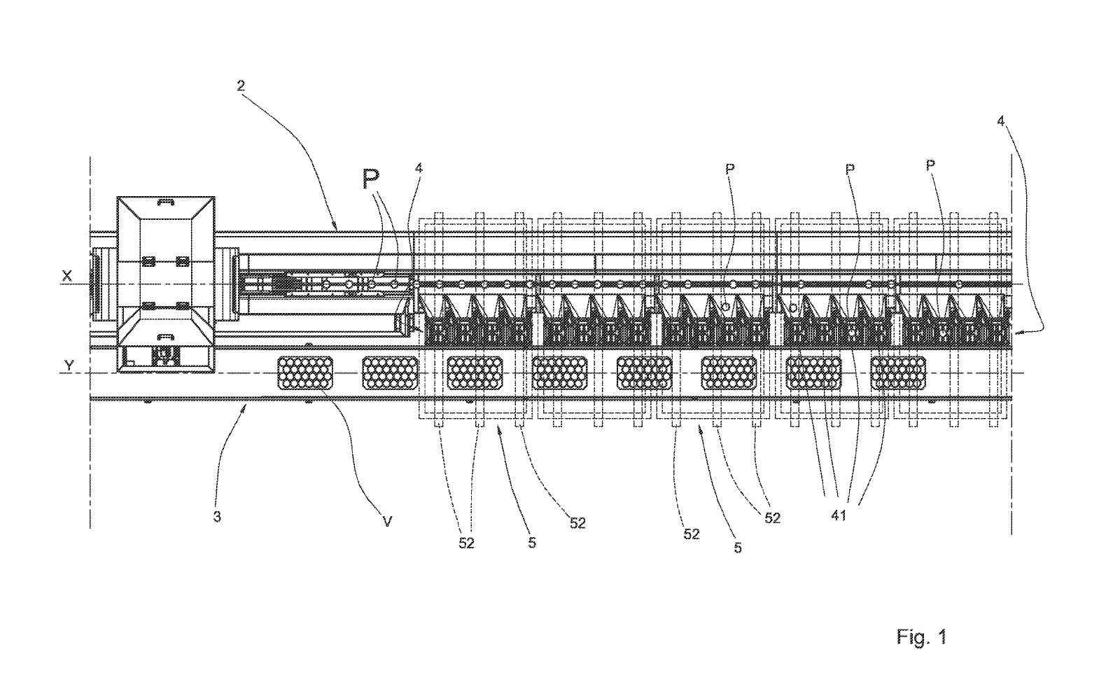

FIG. 1 is a schematic plan view of the system according to the present invention;

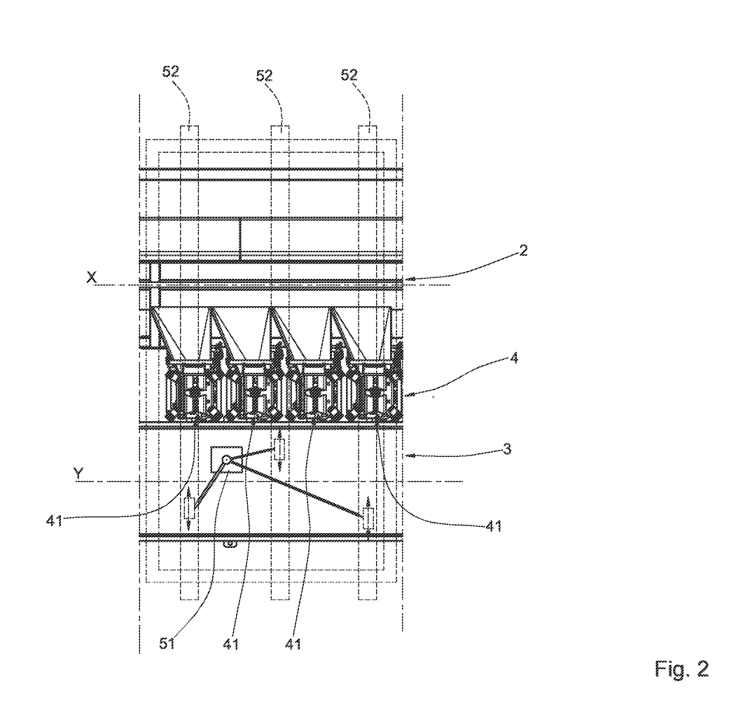

FIG. 2 is an enlarged view of the system appearing in FIG. 1.

With reference to the attached figures, the system for packaging products according to the present invention comprises a sorting machine (2) equipped with a conveying device predisposed to move the products (P) along a first direction (X). The sorting machine further comprises a weighing device, located in a predetermined position, where all the products (P) pass individually. The weighing device detects the weight of each product (P) moving on the sorting machine. The information concerning weight is then stored in a control unit predisposed to manage the operations of the system. The sorting machine (2) is not described in greater detail as it is a device known to the person skilled in the art.

The system according to the present invention further comprises a conveyor line (3) predisposed to move a plurality of trays (V) along a second direction (Y). As schematized in FIG. 1, the trays (V) have a plurality of shaped hollows, each intended to receive a product (P). At the end of the conveyor line (3), each tray (V) will be substantially filled with products (P).

An orientation device (4) is predisposed to receive the products (P) from the sorting machine (2) and to orientate the products (P) in a predetermined manner. The orientation device is typically predisposed to arrange the products (P) with an axis thereof orientated in the space in a predetermined manner. The orientation device is known to the person skilled in the art and therefore it will not be described in further detail herein.

The system according to the present invention is also provided with a positioning device (5) that is predisposed to pick up the products (P) from the orientation device (4) and to position the products (P) in predetermined positions along the conveyor line (3).

The sorting machine (2) and the conveyor line (3) are advantageously arranged in such a manner that the first direction (X) and the second direction (Y) are parallel to each other. The orientation device (4) is interposed between the sorting machine (2) and the conveyor line (3), and the positioning device (5) is arranged above the orientation device (4) and the conveyor line (3), so as to operate from above with respect thereto.

As can be seen in FIG. 1, the layout of the sorting machine (2), the conveyor line (3), the orientation device (4) and the positioning device makes it possible to limit to a considerable extent the dimensions of the system in a direction perpendicular to the first and the second direction (X, Y). This makes it possible to arrange a number of systems according to the present invention side by side within the same facility, while allowing for corridors that are substantially rectilinear in extension between one and the other.

In order to further reduce the dimensions of the system in a direction perpendicular to the advancement directions (X,Y), the orientation device (4) comprises a plurality of cradles (41), each of which is positioned so as to receive a product (P) coming from the sorting machine (2). The cradles (41) are side by side of each other along a direction parallel to the first direction (X) and to the second direction (Y). Each cradle (41) is equipped with a detection sensor for detecting the presence of a product (P).

To facilitate the transfer of the products (P) from the sorting machine (2) to the orientation device (4), the sorting machine (2) comprises an unloading system predisposed to unload each individual product (P) from the sorting machine (2) to the orientation device (4) in a direction transverse to the first direction (X). Specifically, the conveying device of the sorting machine (2) comprises a plurality of supports that are aligned and movable along the first direction (X). These supports have not been represented in a detailed manner because they are known to the person skilled in the art. Each support is intended to support a product (P). The unloading system of the sorting machine (2) comprises a plurality of unloading mechanisms, which are not illustrated in a detailed manner as they are known to the person skilled in the art, and each of which is predisposed to laterally overturn a support for a product (P). Each unloading mechanism is positioned so as to bring about the unloading of a product (P) onto a cradle (41) of the orientation device (4). With this aim, each unloading mechanism is positioned slightly upstream of a cradle (41), so that the combination of the advancement motion of the products (P) and the product unloading motion produced by the unloading mechanism brings the product (P) to the cradle (41) corresponding to the unloading mechanism itself.

An alternative unloading system for the sorting machine (2), which is not illustrated in detail as it is known to the person skilled in the art, is structured so as to unload the fruit with one or more trapdoor mechanisms, in a direction sloping downward in a more pronounced manner. In this solution, the orientation device (4) can be placed, at least partially, beneath the sorting machine (2), thereby allowing for further reduction of the plan dimensions of the system.

The configuration of the sorting machine (2), particularly the possibility of laterally unloading the products (P) with respect to the first direction (X), and the configuration of the orientation device (4) which comprises a plurality of cradles (41) that are side by side and aligned parallel to the first direction (X), make it possible to arrange the sorting machine (2), the orientation device (4) and the conveyor line (3) set very close alongside each other, leading to further limiting of the dimensions of the system in the direction transverse to the conveying directions (X,Y).

In a preferred embodiment, the positioning device (5) comprises a plurality of manipulators (51). Each manipulator (51) is provided with a grip member that is movable in the space above the orientation device (4) and the conveyor line (3) so as to pick up a product (P) from the orientation device (4) and place the product (P) in a predetermined position on the conveyor line (3). The use of a positioning device (5) placed above the orientation device (4) and the conveyor line (3) allows for further reduction of the transverse dimensions of the system. A particularly advantageous example of the positioning device (5) is represented by a plurality of devices of the “pick-and-place” type. The “pick-and-place” devices are not illustrated in detail as they are known to the person skilled in the art and each “pick-and-place” device comprises a manipulator (51) that is articulated to the ends of three articulated arms. Each articulated arm, at the other end, is articulated to a slider that is movable along a sliding direction. The sliding directions of the three sliders are parallel to each other. The three sliders associated with each manipulator can be slidable along respective tracks (52), which are only schematically illustrated in FIG. 1. In this manner, the manipulators (51) are movable beneath the tracks (52) and above the orientation device (4) and the conveyor line (3). The system according to the present invention comprises a control unit predisposed to store the weight and position of each product (P) within the system.

For this purpose, the sorting machine (2) can be provided with an encoder that detects the advancement of the conveying device. In this manner, each time a product (P) is weighed, the control unit can store the weight and position thereof and keep track of the advancement of the product (P) along the sorting machine (2).

With the position of each product (P) on the sorting machine (2) being known, the control unit is capable of monitoring each successive movement of the products (P) within the system. With this aim, the control unit is predisposed to determine the activation of the unloading mechanisms of the sorting machine (2) for the purpose of unloading the advancing products (P) onto the first free cradle (41) where they are in transit. As mentioned above, given that each cradle (41) is equipped with a detection sensor, the control unit is capable of establishing which cradles (41) are free and which are not. In this manner, the control unit knows the weight of each product (P) present on each cradle (41) in real time.

The control unit is also predisposed to store the position of each tray (V) that is moving along the conveyor line. For this purpose, the conveyor line (3) can be equipped with an encoder and/or one or more photocells for detecting the presence of the trays (V) in transit.

Once the weight of each product (P) present on each cradle (41) and the position of each tray (V) along the conveyor line (3) are known, the control unit commands the positioning device (5) so that it arranges each product (P) in a given position on the conveyor line (3), inside a tray (V), so as to form groups of products (P) of a total weight close to a given weight. In fact, knowing the weight of each product (P) that is placed in succession on each tray (V), the control unit knows in real time the total weight of each tray (V) that is gradually being filled with products (P). In this manner, as it also knows the weight of each product (P) present on each cradle (41), the control unit is capable of directing the positioning device (5) to pick up the products (P), the weight of which makes it possible to obtain a total weight for the tray (V) closest to a standard weight. In the preferred embodiment of the system, in which the positioning device (5) comprises a plurality of “pick-and-place” manipulators, the control carried out by the control unit is implemented substantially by controlling the strokes of the three sliders associated with each manipulator (51).

All the controls and procedures described are performed in real time during the movement of the products (P) along the sorting machine (2) and the movement of the trays (V) along the conveyor line (3). In this manner, the system makes it possible to expedite the packaging of the products to a considerable degree. Furthermore, the packaging process is entirely managed by the control unit and the presence of employees is not substantially required, unless for general monitoring of the entire system.

1. A system for packaging products, characterised in that it comprises: a sorting machine (2) equipped with a conveying device predisposed to move the products (P) along a first direction (X) and a weighing machine for detecting the weight of each product (P); a conveyor line (3) predisposed to move a plurality of trays (V) along a second direction (Y); an orientation device (4) predisposed to receive the products (P) from the sorting machine (2) and to orientate the products (P) in a predetermined manner; a positioning device (5) predisposed to pick up the products (P) from the orientation device (4) and to position the products (P) in predetermined positions along the conveyor line (3); the orientation device (4) is interposed between the sorting machine (2) and the conveyor line (3); the first direction (X) and the second direction (Y) are parallel to each other; the positioning device (5) is arranged above the orientation device (4) and the conveyor line (3) so as to operate from above with respect thereto.

2. The system according to claim 1, wherein the orientation device (4) comprises a plurality of cradles (41), each of which is positioned so as to receive a product (P) coming from the sorting machine (2).

3. The system according to claim 2, wherein the cradles (41) are placed side by side along a direction parallel to the first direction (X) and the second direction (Y).

4. The system according to claim 1, wherein the sorting machine (2) comprises an unloading system predisposed to unload each individual product (P) from the sorting machine (P) to the orientation device (4) in a direction transverse to the first direction (X).

5. The system according to claim 1, wherein the sorting machine (2) comprises an unloading system structured to unload the fruit downward, beneath the sorting machine (2), by means of one or more trapdoor mechanisms.

6. The system according to claim 1, wherein the positioning device (5) comprises a plurality of manipulators (51), each being provided with a grip member that is movable in the space above the orientation device (4) and the conveyor line (3) so as to pick up a product (P) from the orientation device (4) and place the product (P) in a predetermined position on the conveyor line (3).

7. The system according to claim 1, comprising a control unit predisposed to store the weight and position of each product (P) within the system and to control the operation of the sorting machine (2) and the positioning device (5) so that: the sorting machine (2) unloads each product (P) in a first available position of the orientation device (4) during advancement along the first direction (X); the positioning device (5) arranges each product (P) in a given position on the conveyor line (3), inside a tray (V), so as to form groups of products (P) of a total weight close to a given weight.
